(19) United States
(12) Patent Application Publication
(10) Pub. No.: US 2024/0010529 A1
(43) Pub. Date: Jan. 11, 2024

(54) COMBINED ELECTROCHEMICAL ADVANCED OXIDATION PROCESS FOR REMOVAL OF ORGANIC CONTAMINATION IN WATER

(71) Applicant: Evoqua Water Technologies LLC, Pittsburgh, PA (US)

(72) Inventors: SIMON P. DUKES, Chelmsford, MA (US); GEORGE Y. GU, Austin, TX (US); JOSHUA GRIFFIS, Ashburnham, MA (US); YANG CHEN, Lowell, MA (US)

(73) Assignee: Evoqua Water Technologies LLC, Pittsburgh, PA (US)

(21) Appl. No.: 18/033,066

(22) PCT Filed: Oct. 19, 2021
(86) PCT No.: PCT/US2021/055665

§ 371 Date: Apr. 20, 2023

Related U.S. Application Data
(60) Provisional application No. 63/093,338, filed on Oct. 19, 2020.

(51) Int. Cl. C02F 1/467; C02F 1/72; C02F 1/461; C02F 1/78

(52) U.S. Cl. CPC C02F 1/4672; C02F 1/722; C02F 1/46109; C02F 1/78; C02F 2305/023; C02F 2305/026; C02F 2001/46142; C02F 2001/46147; C02F 2103/346

(57) ABSTRACT

Methods of treating water having organic contaminants are disclosed. The methods include performing a first treatment on the water effective to oxidize a predetermined amount of the organic contaminant and electrochemically treating the water. The methods include introducing a hydrogen peroxide (H₂O₂) containing reagent into the water, allowing the H₂O₂ containing reagent to react with the organic contaminant for a reaction time effective to oxidize a predetermined amount of the organic contaminant, and electrochemically treating the water. Systems for treating water are also disclosed. The systems include an electrochemical cell, a source of an H₂O₂ containing reagent upstream from the electrochemical cell, and a controller operable to regulate a reaction time of the H₂O₂ containing reagent in the water and a potential applied to the electrochemical cell.

### CROSS-REFERENCE TO RELATED APPLICATIONS

This application claims priority under 35 U.S.C. §119(e) to U.S. Provisional Application Ser. No. 63/093,338 titled “Combined Electrochemical Advanced Oxidation Process for Removal of Organic Contamination in Water” filed on Oct. 19, 2020, which is herein incorporated by reference in its entirety for all purposes.

### FIELD OF TECHNOLOGY

Aspects and embodiments disclosed herein relate to methods of treating water comprising at least one organic contaminant. In particular, aspects and embodiments disclosed herein relate to methods of treating water with oxidation and electrochemical processes.

### SUMMARY

In accordance with one aspect, there is provided a method of treating water. The method may comprise providing a water comprising a first concentration of at least one organic contaminant. The method may comprise performing a first treatment on the water effective to oxidize a predetermined amount of the at least one organic contaminant and produce a first treated water having a second concentration of the at least one organic contaminant. The method may comprise electrochemically treating the first treated water with an electrochemical cell comprising a cathode and an anode comprising an anodic oxidation material to produce a second treated water having a third concentration of the at least one organic contaminant.

In some embodiments, the first treatment is selected from an advanced oxidation process (AOP) with a hydrogen peroxide (H₂O₂) containing reagent, an ultraviolet advanced oxidation process (UV-AOP), an ultrasonic cavitation advanced oxidation process, and an electrochemical advanced oxidation process.

In some embodiments, the H₂O₂ containing reagent is selected from peroxone and Fenton's reagent.

In some embodiments, the predetermined amount of the at least one organic contaminant oxidized is at least about 25% of the at least one organic contaminant in the water.

In some embodiments, the anodic oxidation material is selected from platinum, titanium oxide, a mixed metal oxide (MMO) coated dimensionally stable anode (DSA) material, graphite, graphene, boron doped diamond (BDD), lead/lead oxide, and combinations thereof.

The method may further comprise measuring a concentration of the at least one organic contaminant in at least one of the water, the first treated water, and the second treated water.

The method may further comprise controlling a parameter of the first treatment responsive to the measured concentration of the at least one organic contaminant.

In accordance with another aspect, there is provided a method of treating water. The method may comprise introducing a hydrogen peroxide (H₂O₂) containing reagent into a water comprising at least one organic contaminant. The method may comprise allowing the H₂O₂ containing reagent to react with the at least one organic contaminant for a reaction time effective to oxidize a predetermined amount of the at least one organic contaminant to produce a first treated water. The method may comprise electrochemically treating the first treated water with an electrochemical cell comprising a cathode and an anode comprising an anodic oxidation material to produce a second treated water.

In some embodiments, the method may further comprise introducing the first treated water into an inlet of the electrochemical cell.

The method may comprise measuring a concentration of the at least one organic contaminant in the water.

The method may comprise introducing the H₂O₂ containing reagent at a predetermined rate responsive to the measured concentration of the at least one organic contaminant.

The method may further comprise measuring a concentration of the at least one organic contaminant in at least one of the water, the first treated water, and the second treated water.

The method may further comprise controlling the reaction time responsive to the measured concentration of the at least one organic contaminant.

In some embodiments, the H₂O₂ containing reagent is selected from peroxone and Fenton's reagent.

In some embodiments, the predetermined amount of the at least one organic contaminant oxidized is at least about 25% of the at least one organic contaminant in the water.

In some embodiments, the anodic oxidation material is selected from platinum, titanium oxide, a mixed metal oxide (MMO) coated dimensionally stable anode (DSA) material, graphite, graphene, boron doped diamond (BDD), lead/lead oxide, and combinations thereof.

In some embodiments, the method may comprise dosing the first treated water with a second amount of the H₂O₂ containing reagent.

In accordance with another aspect, there is provided a system for treating water. The system may comprise an electrochemical cell having an inlet and an outlet, the inlet of the electrochemical cell fluidly connectable to a source of water comprising at least one organic contaminant. The electrochemical cell may comprise a cathode and an anode comprising an anodic oxidation material. The system may comprise a source of a hydrogen peroxide (H₂O₂) containing reagent positioned upstream of the electrochemical cell. The system may comprise a controller operably connected to the electrochemical cell and the source of the H₂O₂ containing reagent, the controller operable to generate a control signal that regulates a reaction time of the H₂O₂ containing reagent in the source of water and a potential applied to the electrochemical cell.

In some embodiments, the controller is operable to generate the control signal regulating the reaction time to be effective to oxidize a predetermined amount of the at least one organic contaminant prior to applying the potential to the electrochemical cell.

The system may further comprise a composition sensor fluidly connected to the electrochemical cell configured to measure a concentration of the at least one organic contaminant in at least one of a first treated water and a second treated water.

In some embodiments, the controller is operable to generate the control signal regulating the reaction time responsive to the measurement of the concentration of the at least one organic contaminant.

The system may comprise a reactor having a first inlet fluidly connectable to the source of water, a second inlet fluidly connectable to the source of the H₂O₂ containing reagent, and an outlet fluidly connectable to the inlet of the electrochemical cell.

The system may further comprise a recycle line extending from a recycle outlet of the electrochemical cell to a recycle inlet of the reactor.

The system may further comprise a recycle loop extending from a recycle outlet of the electrochemical cell to a recycle inlet of the electrochemical cell.

In some embodiments, the H₂O₂ containing reagent is selected from peroxone, and Fenton's reagent.

In some embodiments, the anodic oxidation material is selected from platinum, titanium oxide, a mixed metal oxide (MMO) coated dimensionally stable anode (DSA) material, graphite, graphene, boron doped diamond (BDD), lead/lead oxide, and combinations thereof.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a box diagram of an exemplary system for treating water, according to one embodiment;

FIG. 2 is a box diagram of an exemplary system for treating water, according to one embodiment;

FIG. 3A is a box diagram of an exemplary system for treating water, according to one embodiment;

FIG. 3B is a box diagram of an exemplary system for treating water, according to one embodiment;

FIG. 4 is a graph showing total organic carbon (TOC) of a humic acid solution during treatment, according to one embodiment;

FIG. 5 is a graph showing TOC of an ethylene glycol solution during treatment, according to one embodiment;

FIG. 6 is a graph showing TOC of an organic mixture during treatment, according to one embodiment;

FIG. 7 is a graph showing TOC of a simulated wastewater during treatment, according to one embodiment;

FIG. 8A is a graph showing TOC of a wastewater treated with Fenton's reaction;

FIG. 8B is a graph showing TOC of a wastewater treated with peroxone;

FIG. 8C is a graph showing TOC of a wastewater treated with electrochemical oxidation;

FIG. 8D is a graph showing TOC of a wastewater treated with peroxone followed by an electrochemical reaction, according to one embodiment; and

FIG. 8E is a graph showing TOC of a wastewater treated with peroxone followed by an electrochemical reaction with additional peroxone dosing, according to one embodiment.

### DETAILED DESCRIPTION

Advanced oxidation processes (AOP) may be used for the destruction or inactivation of undesirable organic compounds. In general, AOP are chemical treatment procedures designed to remove organic materials in water by oxidation through reactions with free radicals. These organic compounds can be found in high purity water such as water used in semiconductor manufacturing or in drinking water. These organic compounds may comprise endocrine disrupting chemicals and may also be found in wastewater.

AOP treatments generally utilize activation of an oxidizing salt for the destruction or elimination of organic species. Any salt that can initiate as a precursor to produce an oxidizing free radical may be utilized. Exemplary methods for activation of the oxidant include ultraviolet (UV) irradiation (UV-AOP), ultrasonic cavitation, application of an electrochemical potential, and other methods. Exemplary oxidants that may be activated include oxygen gas (O₂), ozone (O₃), hydrogen peroxide (H2O₂), and persulfate.

Alternatively, it has been found that an effective amount of oxidation may be performed by dosing the water with a strong oxidant, such as certain hydrogen peroxide containing reagents. The strong oxidation may not require activation with an energy source for effective destruction of the organic contaminants. When Fenton's reagent, an exemplary iron-based hydrogen peroxide containing reagent, is utilized as the oxidant for the systems and methods described herein, the activation into its radical forms generally occurs according to the following reaction pathway:

Fe²⁺+H₂O₂→Fe³⁺+HO·+OH⁻ (1)

Fe³⁺+H₂O₂→Fe²⁺+HOO·+H⁺ (2)

resulting in the net reaction:

2H₂O₂→HO·+HOO·°H₂O (3)

Iron(II) is oxidized by hydrogen peroxide to iron(III), forming a hydroxyl radical and a hydroxide ion in the process. Iron(III) is then reduced back to iron(II) by another molecule of hydrogen peroxide, forming a hydroperoxyl radical and a proton. The net effect is a disproportionation of hydrogen peroxide to create two different oxygen-radical species, with water (H⁺+OH⁻) as a byproduct. The free radicals generated by this process then engage in secondary reactions. The hydroxyl, as a powerful, non-selective oxidant, oxidizes the organic compound in a rapid and exothermic reaction that results in the destruction of the organic contaminant to primarily carbon dioxide and water. Other hydrogen peroxide containing reagents follow a similar reaction pathway that results in the destruction of the organic contaminant.

Additional hydroxyl radicals may be produced by activation, for example, ultraviolet irradiation, ultrasonic cavitation, or electrochemical treatment. Ultraviolet irradiation may be provided, for example, by an ultraviolet lamp. For instance, the systems and methods disclosed herein may include the use of one or more UV lamps, each emitting light at a desired wavelength in the UV range of the electromagnetic spectrum. For instance, according to some embodiments, the UV lamp may have a wavelength ranging from about 180 to about 280 nm, and in some embodiments, may have a wavelength ranging from about 185 nm to about 254 nm.

Ultrasonic cavitation may be provided, for example, by an acoustic energy source. For instance, systems and methods disclosed herein may include use of one or more ultrasonic transducers emitting acoustic energy at a desired frequency in the ultrasound range. For instance, according to some embodiments, the ultrasonic transducer may emit acoustic energy at a frequency of 20 kHz or greater.

Electrochemical activation may be provided, for example, by an electrochemical cell having a cathode and an anode. The cathode and/or anode may be formed in a variety of shapes, for example, planar or circular. In at least some embodiments, the cathode and/or anode may be characterized by a foil, mesh, or foam structure, which may be associated with a higher active surface area, pore structure, and/or pore distribution that can provide ample active sites for the surface reactions to occur. For example, the cathode and/or anode may have an active area of from 1 cm² to 1000 cm².

Such electrochemical activation reactions may generally occur in a bulk of the water being treated. However, in certain embodiments, activation reactions may occur on the surface of the cathode. Thus, in certain embodiments, the cathode material may be selected to be a catalytic material that promotes activation of hydrogen sulfide to the hydroxyl free radical. In some embodiments, the catalytic material for the cathode may include a metal selected from the group consisting of iron, copper, nickel, cobalt, and metal alloys. Alloys may be between any of iron, copper, nickel, cobalt and another metal or another suitable material. For example, an electrode may be steel, an alloy comprising at least iron and carbon. An exemplary cathode material is copper.

Another method of destroying organic contaminants is electrochemical oxidation. Electrochemical oxidation reactions generally occur on the surface of the anode. The anode material may be selected to be an anodic oxidation material that promotes oxidation of the organic contaminant. Exemplary anode materials include platinum, titanium oxide, a mixed metal oxide (MMO) coated dimensionally stable anode (DSA) material, graphite, graphene, boron doped diamond (BDD), or lead/lead oxide. DSA materials may be uncoated or may be coated with noble metals or metal oxides, such as IrO₂, among others. Titanium oxide electrode materials may have a composition that follows the equation TiₙO₂ₙ₋₁ (n=3−10), for example, Ti₃O₅, Ti₄O₇, Ti₅O₉, Ti₆O₁₁, and others. One exemplary titanium oxide electrode material is Ti₄O₇, sometimes referred to as a Magneli phase titanium oxide. Magneli phase titanium oxide electrodes and electrochemical cells comprising said electrodes are described in International Application Publication No. WO2020041712 (filed Aug. 23, 2019, titled “System and method for electrochemical oxidation of polyfluoroalkyl substances in water”), the disclosure of which is herein incorporated by reference in its entirety for all purposes. Another exemplary anode material is platinum, as its current-induced oxidation may be neglected at low current densities. Platinum may be used as a solid conductor or may be used as a coating on another electrode substrate, such as titanium. Platinum, graphite, or graphene may be uncoated or coated with an anodic oxidation material.

In some embodiments, the electrochemical cell may include a reference electrode, for example, in proximity to the cathode. A reference electrode may allow for continuous measurement of the potential of the working electrode, that is, the cathode, without passing current through it. The use of a reference electrode thus may allow for precise control over the cell voltage in water have a specific conductivity, therefore controlling the current that determines the reaction kinetics as described herein to limit competing reactions.

Thus, in accordance with one or more embodiments, systems and methods disclosed herein relate to the removal of organic compounds from a source of contaminated water. In certain embodiments, the source of the water may be associated with a semiconductor manufacturing system or process. For instance, the contaminated water may be a solution used for semiconductor chip or wafer manufacturing.

In certain instances, the disclosure may refer to semiconductor manufacturing systems. However, it should be noted that the systems and methods disclosed herein may similarly be employed in association with any source of water including organic contaminants. For example, the source of the aqueous solution may be associated with a water purification, nuclear power generation, microelectronics manufacturing, semiconductor manufacturing, food processing (including agricultural uses and irrigation), textile manufacturing, paper manufacturing and recycling, pharmaceutical manufacturing, chemical processing, and metal extraction system or process. The source of the water may be associated with industrial applications, for example, with the removal of organic contaminants from industrial wastewaters. The source of the water may be associated with wastewater and/or municipal water treatment.

The effluent produced by the systems and methods disclosed herein may meet regulatory discharge requirements. In some embodiments, the effluent produced by the systems or methods disclosed herein may be collected and used for a variety of applications including semiconductor manufacturing, industrial applications, laboratory applications, medical grade uses, pharmaceutical manufacturing, beverage and food preparation, irrigation water, and agricultural applications.

In accordance with one or more embodiments, water to be treated may contain one or more target compounds. Target organic contaminants may be in the form of alkanes, alcohols, ketones, aldehydes, acids, or others. Water from a source of water may contain various target organic compounds, for example, t-butanol and naturally occurring high molecular weight organic compounds, for example, humic acid or fulvic acid. The water may also or alternatively contain man-made organic molecules such as 1,2,4-triazole or perfluoroalkyl substances (PFAS), for example perfluorooctanoic acid (PFOA). This disclosure is not limited to the types of organic compounds being treated.

In certain embodiments, the systems and methods disclosed herein are useful for removal and concentration of perfluoroalkyl substances (PFAS). As disclosed herein, perfluoroalkyl substances also include polyfluoroalkyl substances. Perfluoroalkyl substances are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end.

PFAS are man-made chemicals used in a lot of industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

Thus, in accordance with one aspect, there is provided a method of treating a waste stream containing at least one organic contaminant. The waste stream may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background TOC is 50 ppm, a conventional PFAS removal treatment, such as an activated carbon column, may exhaust very quickly. Thus, it may be important to remove TOC prior to treatment to remove PFAS.

Thus, in some embodiments, the systems and methods disclosed herein may be used to remove background TOC, prior to treating the water for removal of PFAS. The methods may be useful for oxidizing target organic alkanes, alcohols, ketones, aldehydes, acids, or others in the water. In some embodiments, the waste stream may contain at least 1 ppm TOC. For example, the waste stream may contain at least 1 ppm-10 ppm TOC, at least 10 ppm-50 ppm TOC, at least 50 ppm-100 ppm TOC, or at least 100 ppm-500 ppm TOC.

The methods of treating water having at least one organic contaminant disclosed herein may comprise performing a first treatment on the water effective to oxidize a predetermined amount of the organic contaminant. The first treated water may have a lower TOC concentration than the untreated water. The methods may further comprise electrochemically treating the first treated water to oxidize an amount of the remaining organic contaminant and produce a second treated water having an even lower TOC concentration. In certain embodiments, the electrochemical treatment may be performed responsive to the TOC concentration of the treated water being above a predetermined threshold.

The first treatment may comprise an advanced oxidation process (AOP). The AOP treatment may comprise introducing a strong oxidant into the water to be treated, such as a hydrogen peroxide (H₂O₂) containing reagent. Exemplary H₂O₂ containing reagents that may be employed in the methods disclosed herein include peroxone and Fenton's reagent. Peroxone is a reagent that includes ozone and H₂O₂. Fenton's reagent is a solution of H₂O₂ with ferrous iron, typically iron(II) sulfate (FeSO₄). The reaction may generate oxidizing free radicals, such as hydroxyl free radicals, that destroy at least some of the organic contaminant in the water.

In other embodiments, the first treatment may comprise introducing an oxidant into the water to be treated and applying an activating treatment to produce oxidizing free radicals. The oxidant may comprise, for example, oxygen gas, ozone, hydrogen peroxide, and/or persulfate. The activating treatment may comprise, for example, UV irradiation (UV-AOP), ultrasonic cavitation, and application of an electrochemical potential.

The first treatment may be controlled to oxidize a predetermined amount of the organic contaminant. In certain embodiments, the first treatment may be controlled to oxidize at least about 20% of the organic contaminant, for example, at least about 25%, at least about 33%, at least about 50%, or at least about 75%. The first treatment may be controlled to oxidize about 20% to about 50%, about 40% to about 60%, or about 50% to about 75% of the organic contaminant in the water.

The first treatment may be controlled by varying one or more parameter, such as, reaction time, concentration of the oxidant (e.g., H₂O₂ containing reagent), rate of introducing the oxidant (e.g., H₂O₂ containing reagent), flow rate, pressure, pH, temperature, ultraviolet light intensity, ultrasound cavitation intensity, and applied electrochemical potential. In particular embodiments, reaction time of the first treatment may be controlled to oxidize the predetermined amount of the organic contaminant. For instance, in certain embodiments, at least one of reaction time, concentration of the oxidant, and rate of introducing the oxidant may be increased to oxidize a greater amount of the organic contaminant. In certain embodiments, for example, in UV-AOP, ultrasonic cavitation, or electrochemical advanced oxidation process embodiments, ultraviolet light intensity, ultrasonic cavitation, intensity, or applied electrochemical potential may be increased to oxidize a greater amount of the organic contaminant. In some embodiments, flow rate of the water containing the contaminant through the system may be decreased to oxidize a greater amount of the organic contaminant. The one or more parameter may be selected to control for a predetermined oxidation rate of the contaminant in the first treatment.

After a predetermined amount of the contaminant is oxidized in the first treatment, a second treatment may be performed. The second treatment may comprise an electrochemical treatment. The electrochemical treatment may involve activation of free radicals, for example, in a bulk of the water and/or at the surface of the cathode, and substantially simultaneous electrochemical oxidation, for example, at the surface of the anode. Without wishing to be bound by theory, it is believed the combination of a first treatment to oxidize a predetermined amount of the organic contaminant followed by a second treatment, comprising both an electrochemical treatment effective to perform activation of free radicals and electrochemical oxidation, has a synergistic effect on destruction of organic contaminants. The synergistic effect is shown to improve overall treatment efficiency and/or reaction time for destruction of organic contaminants (see, e.g., Example 6).

In some embodiments, the first treated water may be dosed with an oxidant immediately prior to or during the electrochemical treatment. The oxidant may comprise, for example, oxygen gas, ozone, hydrogen peroxide, and/or persulfate, as previously described. In certain embodiments, the first treated water may be dosed with the H₂O₂ containing reagent immediately prior to or during the electrochemical treatment.

Overall treatment efficiency may be improved by the combination of processes disclosed herein as compared to the sum of each process alone. In accordance with certain embodiments, the systems and methods disclosed herein may remove from about 50% to about 100% of the organic contaminant, for example, from about 50% to about 75% or from about 75% to about 90%. Longer reactions may be performed to remove about 100% of the organic contaminant. Such treatment efficiency may only be observed in conventional systems after a much longer reaction time. Thus, reaction time may be improved by the combination of processes as compared to the sum of each process alone. In accordance with certain embodiments, reaction time may be reduced by about 50% to about 90%, for example, about 75% to about 87.5% to achieve a similar treatment efficiency as compared to the sum of each process alone.

The method may further comprise measuring a concentration of the at least one organic contaminant. The organic contaminant may be measured in at least one of the water, the first treated water, and the second treated water. In some embodiments, TOC may be measured generally. In some embodiments, a specific chemical or species may be measured, for example, PFAS or a species of PFAS. A parameter of the first treatment or the second treatment may be controlled responsive to the measured concentration of the organic contaminant.

The method may comprise controlling a parameter of the first treatment responsive to the measured concentration of the organic contaminant. For example, the method may comprise controlling at least one of reaction time, concentration of the oxidant (e.g., H₂O₂ containing reagent), rate of introducing the oxidant (e.g., H₂O₂ containing reagent), flow rate, pressure, pH, temperature, ultraviolet light intensity, ultrasound cavitation intensity, and applied electrochemical potential in the first treatment responsive to the measured concentration of the organic contaminant.

The method may comprise controlling a parameter of the second treatment responsive to the measured concentration of the organic contaminant. For example, the method may comprise controlling at least one of reaction time, flow rate, pressure, pH, temperature, and applied electrochemical potential in the second treatment responsive to the measured concentration of the organic contaminant. In some embodiments, the first treated water may be dosed with additional oxidant prior to the second treatment. Thus, in certain embodiments, concentration of the oxidant (e.g., H₂O₂ containing reagent) and/or rate of introducing the oxidant (e.g., H₂O₂ containing reagent) may be controlled responsive to the measured concentration of the organic contaminant in the water, first treated water, or second treated water.

In some embodiments, the methods may comprise measuring one or more parameter selected from flow rate, pressure, pH, temperature, ultraviolet light intensity, ultrasound cavitation intensity, and applied electrochemical potential. The methods may comprise adjusting one or more of such parameters responsive to the measured value. For instance, the methods may comprise adjusting one or more of flow rate, pressure, pH, temperature, ultraviolet light intensity, ultrasound cavitation intensity, and applied electrochemical potential responsive to the measured value. Such adjustment may include, for example, operating a pump, actuating a valve, introducing a pH adjuster, heating or cooling, and/or actuating a UV lamp, ultrasonic transducer, or electrochemical cell.

The method may comprise further treating the second treated water, optionally responsive to the measurement of the organic contaminant in the second treated water being greater than a concentration permitted for discharge. The further treatment may comprise any method of removing or destroying organic contaminants, such as AOP, UV, UV-AOP, ultrasonic cavitation, electrochemical advanced oxidation process, electrochemical oxidation, carbon absorption, and combinations thereof. In certain embodiments, the method may comprise directing the second treated water to an upstream treatment reaction, such as to the first treatment or the second treatment, for further treatment. In some embodiments, the water may be continuously circulated until the measurement of the organic contaminant is within a concentration permitted for discharge.

In accordance with certain aspects, the methods disclosed herein may comprise introducing a hydrogen peroxide (H₂O₂) containing reagent into a water comprising at least one organic contaminant, allowing the H₂O₂ containing reagent to react with the at least one organic contaminant for a reaction time effective to oxidize a predetermined amount of the at least one organic contaminant to produce the first treated water, and electrochemically treating the first treated water to produce a second treated water. In some embodiments, the electrochemical treatment may be performed responsive to a measured concentration of the organic contaminant in the first treated water. In some embodiments, one or both of the rate of introducing the H₂O₂ containing reagent and the reaction time of the water with the H₂O₂ containing reagent may be controlled responsive to a measured concentration of the organic contaminant in the water, the first treated water, or the second treated water.

The electrochemical treatment may be performed in an electrochemical cell comprising a cathode and an anode comprising an anodic oxidation material, optionally the cathode may comprise a catalytic material.

In some embodiments, the method may be performed as a batch reaction. The water and the H₂O₂ containing reagent may be combined in the electrochemical cell, prior to activation of the cathode and the anode. Thus, the methods may comprise introducing the water and the H₂O₂ containing reagent, optionally at a predetermined rate, into the electrochemical cell and allowing the H₂O₂ containing reagent to react with the organic contaminant in the electrochemical cell for the selected reaction time prior to activation of the cathode and the anode.

In other embodiments, the method may be performed as reactions in series. The water and the H₂O₂ containing reagent may be combined in a reactor upstream from the electrochemical cell. Thus, the methods may comprise introducing the water and the H₂O₂ containing reagent, optionally at a predetermined rate, into a reactor, allowing the H₂O₂ containing reagent to react with the organic contaminant in the reactor for the selected reaction time to produce the first treated water, and introducing the first treated water into an inlet of the electrochemical cell.

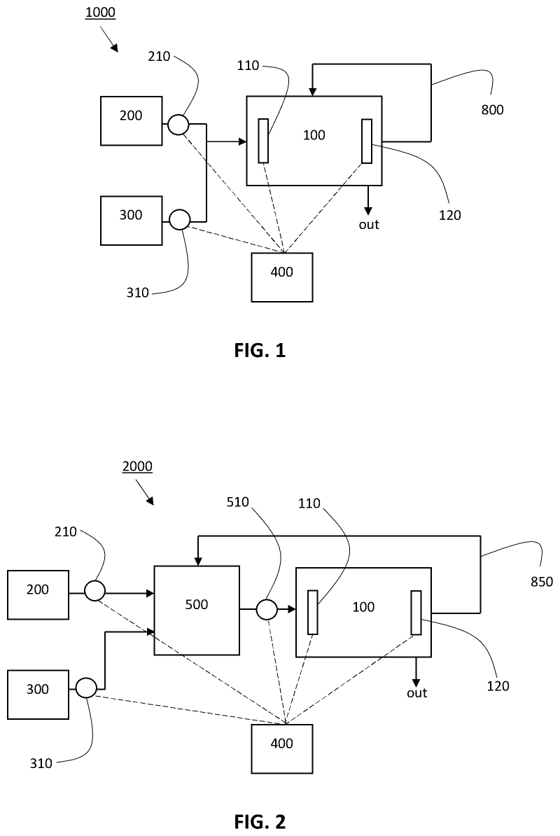

In accordance with certain aspects, there is provided a system for treating water. Exemplary system 1000 is shown in FIG. 1. System 1000 comprises an electrochemical cell 100 having an inlet and an outlet and comprising cathode 110 and anode 120, the inlet of the electrochemical cell 100 fluidly connectable to a source of water 200 comprising at least one organic contaminant. Pump 210 is configured to direct water from the source of water 200 to the electrochemical cell 100. System 1000 comprises a source of an H₂O₂ containing reagent 300 positioned upstream of the electrochemical cell 100 and fluidly connectable to the source of water 200. Pump 310 is configured to direct the H₂O₂ containing reagent to the electrochemical cell 100. System 1000 includes optional recycle loop 800 extending from a recycle outlet of the electrochemical cell 100 to a recycle inlet of the electrochemical cell 100. Thus, in some embodiments, second treated water may be directed back to an inlet of the electrochemical cell 100 for further treatment.

System 1000 comprises a controller 400 operably connected to the electrochemical cell 100 and the source of the H₂O₂ containing reagent 300 (more specifically, to pump 310). Controller 400 is operable to generate a control signal that regulates a reaction time of the H₂O₂ containing reagent in the source of water and a potential applied to the electrochemical cell 100 (more specifically, across cathode 110 and anode 120). Controller 400 may be operable to generate the control signal regulating the reaction time to be effective to oxidize a predetermined amount of the at least one organic contaminant as previously described, prior to applying the potential to the electrochemical cell 100.

Controller 400 may be associated with or more processors typically connected to one or more memory devices, which can comprise, for example, any one or more of a disk drive memory, a flash memory device, a RAM memory device, or other device for storing data. The memory device may be used for storing programs and data during operation of the system. For example, the memory device may be used for storing historical data relating to the parameters over a period of time, as well as operating data. In some embodiments, the controller disclosed herein may be operably connected to an external data storage. For instance, the controller may be operable connected to an external server and/or a cloud data storage.

Any controller disclosed herein may be a computer or mobile device or may be operably connected to a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source.

The controller disclosed herein may be digitally connected to the one or more components. The controller may be connected to the one or more components through a wireless connection. For example, the controller may be connected through wireless local area networking (WLAN) or short-wavelength ultra-high frequency (UHF) radio waves. The controller may further be operably connected to any additional pump or valve within the system, for example, to enable the controller to direct fluids or additives as needed. The controller may be coupled to a memory storing device or cloud-based memory storage.

The controller disclosed herein may be configured to transmit data to a memory storing device or a cloud-based memory storage. Such data may include, for example, operating parameters, measurements, and/or status indicators of the system components. The externally stored data may be accessed through a computer or mobile device. In some embodiments, the controller or a processor associated with the external memory storage may be configured to notify a user of an operating parameter, measurement, and/or status of the system components. For instance, a notification may be pushed to a computer or mobile device notifying the user. Operating parameters and measurements include, for example, properties of the water to be treated or a treated water. Status of the system components may include, for example, potential applied across cathode 110 and anode 120, and whether any system component requires regular or unplanned maintenance. However, the notification may relate to any operating parameter, measurement, or status of a system component disclosed herein. The controller may further be configured to access data from the memory storing device or cloud-based memory storage. In certain embodiments, information, such as system updates, may be transmitted to the controller from an external source.

Multiple controllers may be programmed to work together to operate the system. For example, one or more controller may be programmed to work with an external computing device. In some embodiments, the controller and computing device may be integrated. In other embodiments, one or more of the processes disclosed herein may be manually or semi-automatically executed.

Exemplary system 2000 is shown in FIG. 2. System 2000 is similar to system 1000, except it includes reactor 500 positioned upstream from electrochemical cell 100. Reactor 500 has a first inlet fluidly connectable to the source of water 100, a second inlet fluidly connectable to the source of the H₂O₂ containing reagent 300, and an outlet fluidly connectable to the inlet of the electrochemical cell 100. Pump 510 is configured to direct first treated water from reactor 500 to electrochemical cell 100. Controller 400 is operably connected to reactor 500 (more specifically, pump 510). System 2000 further includes an optional recycle line 850 extending from a recycle outlet of electrochemical cell 100 to a recycle inlet of reactor 500. Thus, in some embodiments, second treated water may be directed back to reactor 500 for further treatment. In certain embodiments, reactor 500 may include a source of activation, for example, a UV lamp or ultrasonic transducer. In certain embodiments of the system 2000 including reactor 500, the source of the H₂O₂ containing reagent 300 may additionally be directly fluidly connected with an inlet of electrochemical cell 100 (as shown in FIG. 1).

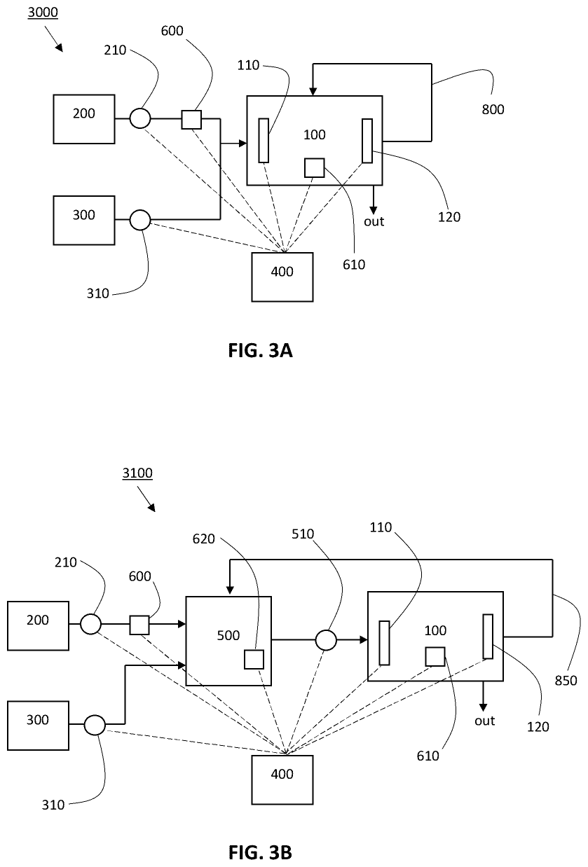

Exemplary system 3000 is shown in FIG. 3A. System 3000 is similar to system 1000, except it includes sensors 600, 610 fluidly connected to the source of the water 200 and the electrochemical cell 100, respectively. Thus, sensors 600, 610 may be configured to measure a parameter of the water (sensor 600) and first treated water or second treated water (sensor 610). Exemplary system 3100 is shown in FIG. 3B. System 3100 is similar to system 2000, except it includes sensors 600, 610, 620. Sensor 620 is fluidly connected to reactor 500 and configured to measure a parameter of the first treated water. In system 3100, sensor 610 is configured to measure a parameter of the second treated water.

Sensors 600, 610, 620 may measure one or more parameters of the system and processes occurring within. The sensors are generally configured to measure a property and deliver a signal representative of that property to controller 400 or other device configured to regulate or monitor operation of the system. For example, the sensors may be non-specific to any particular species, such as a total organic carbon (TOC) sensor. Alternatively, or in addition, the sensors may be chemical specific sensors, for example, configured to measure a concentration of PFAS or a species of PFAS. One of skill in the art can appreciate that the number and specificity of sensors for a system may be chosen based on known contaminants or other properties of the source of water.

In some embodiments, the sensors may be or comprise a flow meter. The flow meter may be configured to measure the flow rate of water from the source of water that enters the electrochemical cell 100 or reactor 500, the flow rate of the first treated water out of reactor 500, or the flow rate of the second treated water out of electrochemical cell 100. In some embodiments, the sensors may be or include a current sensor coupled to the electrochemical cell 100, that is, coupled to at least one of the cathode 110 and the anode 120 of the electrochemical cell 100. The current sensor may be configured to measure at least the current applied to an electrode, such as the cathode 110 or the anode 120, of the electrochemical cell 100. The sensors may be or comprise a pressure sensor, pH meter, temperature sensor, UV light sensor, and/or acoustic energy sensor. In certain embodiments, systems 3000, 3100 may optionally include a source of a pH adjuster and/or a temperature adjuster fluidly connected to electrochemical cell 100 and/or reactor 500.

Thus, controller 400 may be operably connected to sensors 600, 610, 620. In some embodiments, controller 400 is operable to generate the control signal responsive to a measurement obtained from at least one of sensor 600, 610, 620. For example, controller 400 may generate a control signal regulating a parameter of first treatment or second treatment responsive to the measurement of the concentration of the at least one organic contaminant received from one or more sensor 600, 610, 620. Controller 400 may be operable to generate a control signal that regulates one or more of reaction time, concentration of the oxidant (e.g., H₂O₂ containing reagent), rate of introducing the oxidant (e.g., H₂O₂ containing reagent), flow rate, pressure, pH, temperature, ultraviolet light intensity, ultrasound cavitation intensity, and applied electrochemical potential responsive to the measurement of the concentration of the at least one organic contaminant received from one or more sensor 600, 610, 620. Thus, controller 400 may be operable to control a rate or amount of oxidation in the first treatment and/or the second treatment in accordance with the methods described herein.

In some embodiments, the controller 400 may be operably connected to a valve that directs second treated water to recycle loop 800 or recycle line 850 and operable to generate a control signal that recirculates the second treated water continuously until the measurement of the concentration of the organic contaminant received from sensor 610 (of the second treated water) is within a range permitted for discharge. The controller may then generate a control signal that directs the second treated water to an effluent outlet of the system. In other embodiments, controller 400 may be operable to generate a control signal that directs second treated water to one or more downstream reactor or electrochemical cell for further treatment.

The systems disclosed herein may include more than one electrochemical cell connected in any practical arrangement. For example, the systems may include a plurality of electrochemical cells connected in series to provide for different stages of treatment in each electrochemical cell. Thus, electrochemical cell 100 may represent a plurality of electrochemical cells arranged in series. Alternatively, or in addition, the systems may include a plurality of electrochemical cells connected in parallel to increase overall treatment throughput of the water treatment system. Thus, electrochemical cell 100 may represent a plurality of electrochemical cells arranged in parallel.

In accordance with another aspect, there is provided a method of facilitating water treatment. The method may comprise providing a water treatment system as described herein, with the water treatment system comprising an electrochemical cell as described herein. The method may comprise providing a source of an oxidant, e.g., H₂O₂ containing reagent, as described herein. In certain embodiments, the method may comprise providing a reactor having an inlet configured to receive the oxidant and an inlet configured to receive the water to be treated. The reactor may optionally comprise a UV lamp or ultrasonic transducer, as described herein. The method may comprise providing a controller programmed to generate one or more control signals as described herein. The method may comprise providing pumps and/or valves as necessary to carry out the water treatment methods described herein.

The methods of facilitating water treatment may further comprise providing at least sensor, for example, a composition sensor configured to measure a concentration of the organic contaminant or any sensor as described herein. The methods of facilitating water treatment may further comprise instructing a user to connect the water treatment system to the controller and/or to fluidly connect the source of the water to the water treatment system, as described herein.

In accordance with another aspect, there is provided a method of retrofitting a water treatment system comprising an electrochemical cell in fluid communication with a source of water comprising at least one organic contaminant. The method may comprise providing a source of an oxidant, e.g., H₂O₂ containing reagent, and fluidly connecting the source of the oxidant to the electrochemical cell. Optionally, the method may comprise providing a reactor having an inlet configured to receive the oxidant and an inlet configured to receive the water to be treated. The method may comprise fluidly connecting an outlet of the reactor to the electrochemical cell.

In accordance with another aspect, there is provided a method of retrofitting a water treatment system comprising an AOP reactor in fluid communication with a source of an oxidant, e.g., H₂O₂ containing reagent. The method may comprise providing an electrochemical cell as disclosed herein and fluidly connecting the electrochemical cell downstream of the reactor. The electrochemical cell may comprise a cathode and anode as previously described. In certain embodiments, providing an electrochemical cell may include providing one or more of the cathode and the anode. In certain embodiments, fluidly connecting the electrochemical cell to the AOP reactor may comprise deploying the cathode and the anode in the AOP reactor and electrically connecting the cathode and the anode to a power source.

The methods of retrofitting may further comprise providing a controller and operably connecting the controller to a pump and/or valve of the system to carry out the methods of water treatment described herein. The methods of retrofitting may further comprise providing one or more sensor as described herein and operably connecting the sensor to the controller.

### EXAMPLES

The function and advantages of these and other embodiments can be better understood from the following examples. These examples are intended to be illustrative in nature and are not considered to be limiting the scope of the invention.

### Example 1: Treatment of Humic Acid with H₂O₂ (Fenton's Reagent) and Electrochemical Oxidation with a Ti₄O₇ Titanium Oxide Anode

In a 250 ml beaker, 100 mL of 750 ppm humic acid was combined with 8000 ppm NaCl. The sample was analyzed with a TOC sensor, which measured a TOC value of about 250 ppm. The solution was first treated with 1500 ppm H₂O₂ and 500 ppm FeSO₄ for 1 hour. Oxidation was allowed to occur. The pH of the solution was adjusted using H₂SO₄ to avoid formation of the Fe^{2+/3+} precipitate.

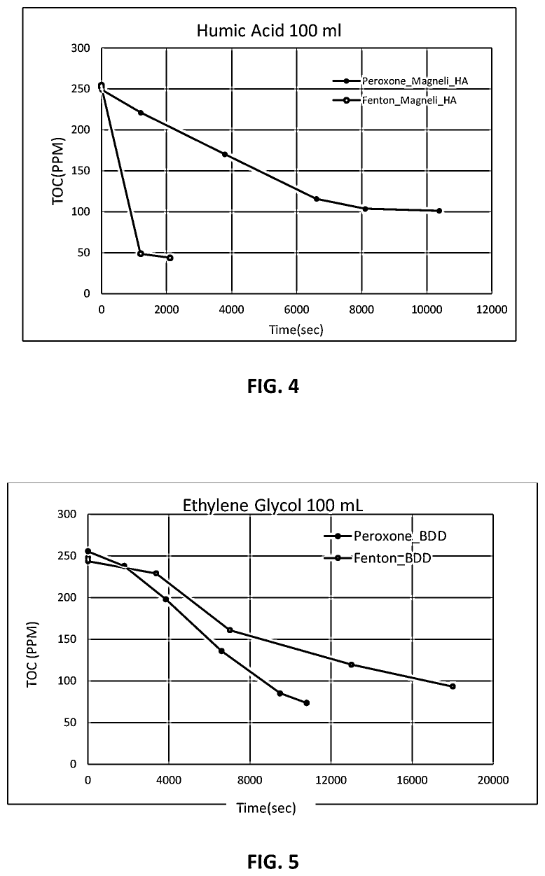

The resulting solution was then electrolyzed in an electrochemical cell with a Magneli phase titanium oxide anode having an area of 8 cm² at a DC current of 0.26 A for 100 mL of the solution. The data is presented in the graph of FIG. 4.

As shown in FIG. 4, the TOC decreased sharply from 250 ppm to less than 50 ppm within 2000 seconds (33.33 minutes) as a result of sequential treatments. Accordingly, the combination of treatments produces an efficient and rapid reduction in TOC.

### Example 2: Treatment of Humic Acid with H₂O₂ (Peroxone) and Electrochemical Oxidation with a Ti₄O₇ Titanium Oxide Anode

The same set up was performed as described in Example 1, except 1000 ppm H₂O₂ was added to a 100 mL sample of humic acid. The electrochemical cell was initiated with a 0.26 DC current and simultaneous bubbling of O₃ generated by the ozone generator. The combination of H₂O₂ and O₃ gas is peroxone. The data is presented in the graph of FIG. 4.

As shown in the graph of FIG. 4, the combination of peroxone with electrochemical oxidation reduced TOC to about 100 ppm after 10000 seconds (166.66 minutes). Accordingly, the combination of treatments produces an efficient and rapid reduction in TOC.

### Example 3: Treatment of Ethylene Glycol with H₂O₂ and Electrochemical Oxidation with a Boron Doped Diamond (BDD) Anode

The same set up was performed as described in Examples 1-2, except 100 mL of 560 ppm ethylene glycol was treated with Fenton's reagent as described in Example 1 and peroxone as described in Example 2. The electrochemical cell was set up with a boron doped diamond (BDD) anode. The data is presented in the graph of FIG. 5.

As shown in FIG. 5, the peroxone treatment reduced TOC to about 75 ppm in about 11000 seconds (183.33 minutes). The Fenton's reagent treatment reduced TOC to slightly below 100 ppm in about 18000 seconds (300 minutes).

### Example 4: Treatment of an Organic Mixture with H₂O₂ and Electrochemical Oxidation with a Boron Doped Diamond (BDD) Anode

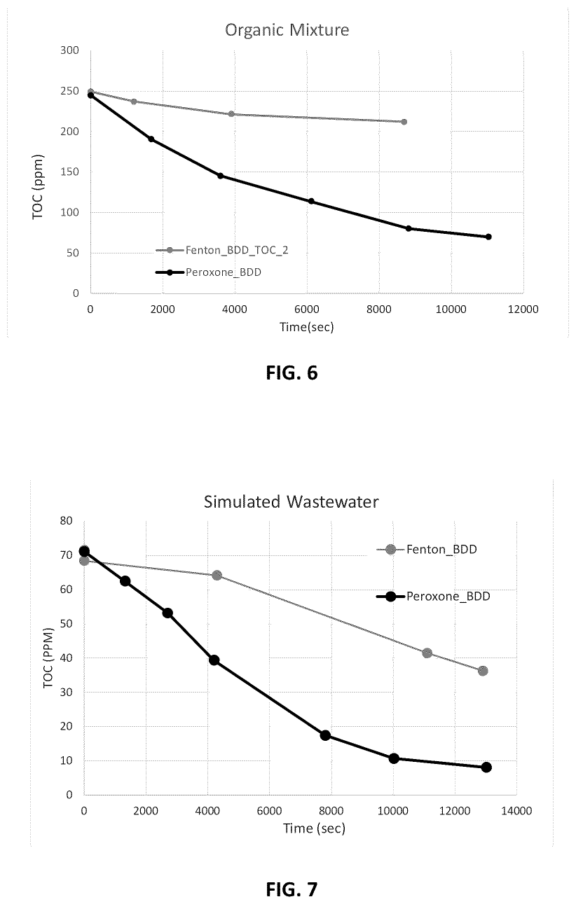

A mixture containing various organic molecules was prepared including the constituents listed in Table 1. The mixture was treated as described in Examples 1 and 2. The electrochemical cell was set up with a boron doped diamond (BDD) anode. The data is presented in the graph of FIG. 6.

TABLE 1
Composition of Organic Mixture

| Molecule | Concentration (ppm) |
|---|---|
| Isopropanol (IPA) | 100 |
| 1,4 dioxane | 100 |
| Hexane | 32 |
| Methyl ethyl ketone (MEK) | 8 |
| 1,2 dichloroethane | 20 |
| Humic acid | 40 |
| Styrene | 20 |
| Tetrahydrofuran (THF) | 100 |
| Trazole | 80 |
| Total Organic Carbon (TOC) | 500 |
| TOC as tested | 250 |

As shown in FIG. 6, the peroxone treatment reduced TOC to about 75 ppm in about 11000 seconds (183.33 minutes). These results are similar as the treatment of ethylene glycol described in Example 4. The Fenton's reagent treatment reduced TOC only to slightly greater than about 200 ppm in about 9000 seconds (150 minutes). It is believed a greater TOC reduction may be observed with a longer reaction time.

### Example 5: Treatment of a Simulated Wastewater with H₂O₂ and Electrochemical Oxidation with a Boron Doped Diamond (BDD) Anode

A mixture prepared to simulate wastewater from a microelectronics (e.g., semiconductor) fabrication operation was treated as described in Examples 1 and 2. The electrochemical cell was set up with a boron doped diamond (BDD) anode. The data is presented in the graph of FIG. 7.

As shown in FIG. 7, the peroxone treatment reduced TOC to less than about 10 ppm in about 11000 seconds (183.33 minutes). The Fenton's reagent treatment reduced TOC to slightly below 40 ppm in about 11000 seconds (183.33 minutes).

### Example 6: Comparative Example of Treatment of Wastewater with Fenton's Reagent, Peroxone, Electrochemical Oxidation, or Peroxone with an Electrochemical Reaction

TOC reduction over time was measured for wastewater treated with each of Fenton's reagent, peroxone, and an electrochemical oxidation alone and compared to TOC reduction for wastewater treated with peroxone followed by an electrochemical reaction, optionally with additional peroxone dosing.

### Fenton's Reaction

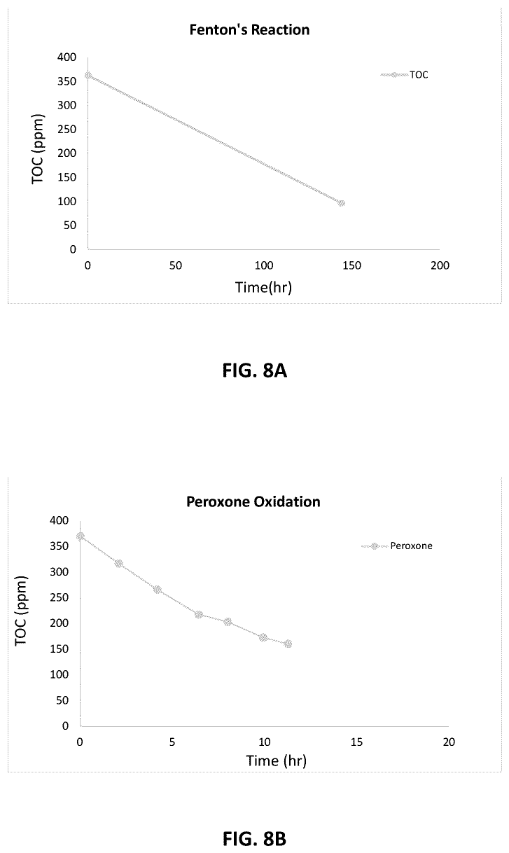

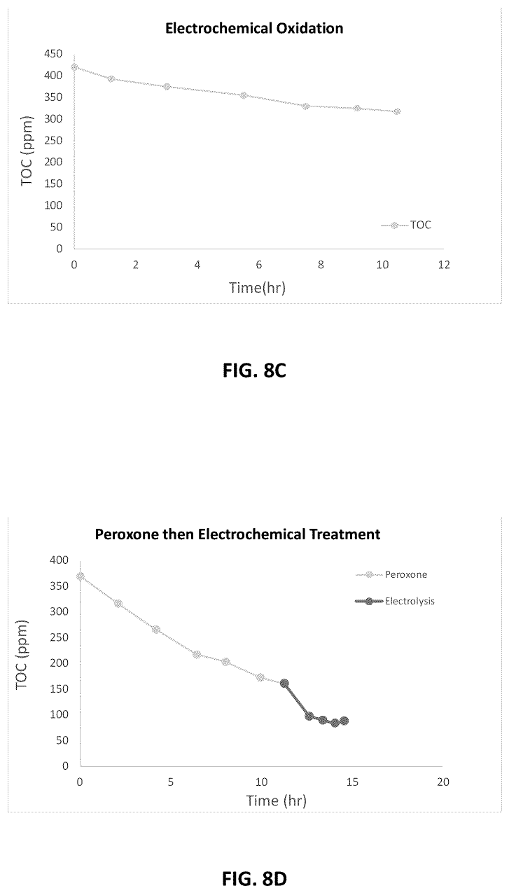

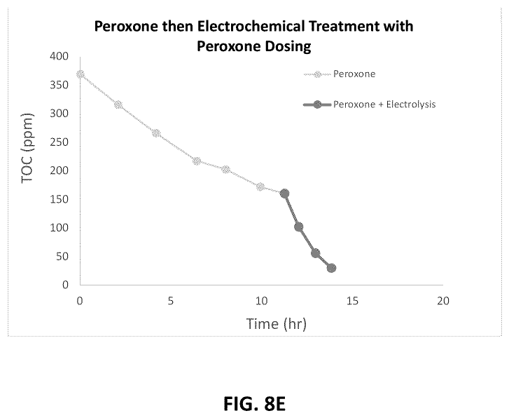

A 2 L sample of an organic wastewater was prepared. 1 gram of Fe²⁺ and 5×10 mL aliquots of 30% H₂O₂ were added to the solution. The reaction was allowed to proceed for about 5 days of residence time. TOC was reduced to about 25% (FIG. 8A).

### Peroxone Oxidation

A 2 L sample of an organic wastewater was prepared. 1 gram of O₃ and 6 g of H₂O₂ were added to the solution. The reaction was allowed to proceed for about 11 hours of residence time. TOC was reduced to about 50% (FIG. 8B).

### Electrochemical Oxidation

A 2 L sample of an organic wastewater was prepared. A current density of 800 A/m² was applied to the solution with a Ti₄O₇ titanium oxide anode. The reaction was allowed to proceed for about 10 hours of residence time. TOC was reduced by about 25% (FIG. 8C).

### Peroxone Oxidation Followed by Electrochemical Reaction

The sample was treated by peroxone oxidation as indicated above for about 11 hours of residence time. After the peroxone oxidation, the sample was treated by electrochemical oxidation as indicated above at a current density of 1000 A/m² for another about 3.4 hours of residence time. TOC was reduced to about 25% (FIG. 8D).

Peroxone Oxidation Followed by Electrochemical Reaction with Peroxone Dosing

The sample was treated by peroxone oxidation as indicated above for about 11 hours of residence time. After the peroxone oxidation, the sample was treated by electrochemical oxidation as indicated above at a current density of 1000 A/m² with additional peroxone dosing for another about 3 hours of residence time. TOC was reduced to about 10% (FIG. 8E).

### Comparative Results

The comparative results are shown in the graphs of FIGS. 8A-8E. As shown in the graph of FIG. 8A, TOC was reduced from 362.5 ppm to 96.75 ppm after 144 hours of treatment with Fenton's reagent. As shown in the graph of FIG. 8B, TOC was reduced from 369.75 ppm to 160.8 ppm after 11.25 hours of treatment with peroxone. As shown in the graph of FIG. 8C, TOC was reduced from 420 ppm to 317.5 ppm after treatment by electrochemical oxidation for 10.5 hours. As shown in the graph of FIG. 8D, TOC was reduced from 369.75 ppm to 87.9 ppm after 14.53 hours of treatment with peroxone followed by an electrochemical reaction. As shown in the graph of FIG. 8E, TOC was reduced from 369.75 ppm to 30.45 ppm after 13.82 hours of treatment with peroxone followed by an electrochemical reaction with additional peroxone dosing.

Specifically, the combined treatment was performed for about 11 hours with peroxone followed by about 3.5 hours of an electrochemical reaction. The peroxone treatment reduced TOC to 160.8 ppm as expected and as seen in the graph of FIG. 8B (peroxone oxidation alone). However, a sharp drop in TOC was observed upon initialization of the electrochemical reaction following the peroxone treatment. TOC was reduced from 160.8 ppm to 87.9 ppm (almost 50% reduction) in about 3.5 additional hours of treatment. The rate of TOC destruction is much greater than the observed TOC reduction with electrochemical oxidation alone as shown in the graph of FIG. 8C and the total TOC reduction in 14.53 hours is comparable to almost 10× more reaction time (144 hours) of treatment with Fenton's reagent alone (FIG. 8A). Accordingly, a synergistic effect is observed with a treatment that includes peroxone oxidation followed by an electrochemical reaction.

Because it is believed the H₂O₂ plays a role in the improved treatment shown by the peroxone and electrochemical reaction combination, it is expected that a similar synergistic effect would be observed with other H₂O₂ containing reagents, such as Fenton's reagent.

Additionally, it is believed the anodic oxidation material plays a role in the improved treatment shown by the Ti₄O₇ and BDD electrodes of the examples. Accordingly, it is expected that a similar synergistic effect would be observed with other anodic oxidation materials as disclosed herein.

An additional combined treatment was performed with about 11 hours of peroxone oxidation followed by about 3 hours of an electrochemical reaction with additional peroxone dosing. The peroxone treatment reduced TOC to 160.8 ppm as expected and as seen in the graph of FIG. 8B (peroxone oxidation alone). However, an even sharper drop in TOC was observed upon initialization of the electrochemical reaction with peroxone dosing following the peroxone treatment. TOC was reduced from 160.8 ppm to 30.45 ppm (about 80% reduction) in about 3 additional hours of treatment. The rate of TOC destruction is much greater than the observed TOC reduction with any of the tested treatments alone as shown in the graph of FIGS. 8A-8C and the total TOC reduction in 13.82 hours is greater than the total TOC reduction shown by peroxone oxidation followed by the electrochemical reaction (FIG. 8D).

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of treating water, comprising:
providing a water comprising a first concentration of at least one organic contaminant;
performing a first treatment on the water effective to oxidize a predetermined amount of the at least one organic contaminant and produce a first treated water having a second concentration of the at least one organic contaminant; and
electrochemically treating the first treated water with an electrochemical cell comprising a cathode and an anode comprising an anodic oxidation material to produce a second treated water having a third concentration of the at least one organic contaminant.

2. The method of claim 1, wherein the first treatment is selected from an advanced oxidation process (AOP) with a hydrogen peroxide (H₂O) containing reagent, an ultraviolet advanced oxidation process (UV-AOP), an ultrasonic cavitation advanced oxidation process, and an electrochemical advanced oxidation process.

3. The method of claim 2, wherein the H₂O₂ containing reagent is selected from peroxone and Fenton's reagent.

4. The method of claim 1, wherein the predetermined amount of the at least one organic contaminant oxidized is at least about 25% of the at least one organic contaminant in the water.

5. The method of claim 1, wherein the anodic oxidation material is selected from platinum, titanium oxide, a mixed metal oxide (MMO) coated dimensionally stable anode (DSA) material, graphite, graphene, boron doped diamond (BDD), lead/lead oxide, and combinations thereof.

6. The method of claim 1, further comprising measuring a concentration of the at least one organic contaminant in at least one of the water, the first treated water, and the second treated water.

7. The method of claim 6, further comprising controlling a parameter of the first treatment responsive to the measured concentration of the at least one organic contaminant.

8. A method of treating water, comprising:
introducing a hydrogen peroxide (H₂O₂) containing reagent into a water comprising at least one organic contaminant;
allowing the H₂O₂ containing reagent to react with the at least one organic contaminant for a reaction time effective to oxidize a predetermined amount of the at least one organic contaminant to produce a first treated water; and
electrochemically treating the first treated water with an electrochemical cell comprising a cathode and an anode comprising an anodic oxidation material to produce a second treated water.

9. The method of claim 8, further comprising introducing the first treated water into an inlet of the electrochemical cell.

10. The method of claim 8, further comprising measuring a concentration of the at least one organic contaminant in the water.

11. The method of claim 10, comprising introducing the H₂O₂ containing reagent at a predetermined rate responsive to the measured concentration of the at least one organic contaminant.

12. The method of claim 8, further comprising measuring a concentration of the at least one organic contaminant in at least one of the water, the first treated water, and the second treated water.

13. The method of claim 12, further comprising controlling the reaction time responsive to the measured concentration of the at least one organic contaminant.

14. The method of claim 8, wherein the H₂O₂ containing reagent is selected from peroxone and Fenton's reagent.

15. The method of claim 8, wherein the predetermined amount of the at least one organic contaminant oxidized is at least about 25% of the at least one organic contaminant in the water.

16. The method of claim 8, wherein the anodic oxidation material is selected from platinum, titanium oxide, a mixed metal oxide (MMO) coated dimensionally stable anode (DSA) material, graphite, graphene, boron doped diamond (BDD), lead/lead oxide, and combinations thereof.

17. The method of claim 8, further comprising dosing the first treated water with a second amount of the H₂O₂ containing reagent.

18. A system for treating water comprising:
an electrochemical cell having an inlet and an outlet, the inlet of the electrochemical cell fluidly connectable to a source of water comprising at least one organic contaminant, the electrochemical cell comprising:
a cathode, and
an anode comprising an anodic oxidation material;
a source of a hydrogen peroxide (H₂O₂) containing reagent positioned upstream of the electrochemical cell; and
a controller operably connected to the electrochemical cell and the source of the H₂O₂ containing reagent, the controller operable to generate a control signal that regulates a reaction time of the H₂O₂ containing reagent in the source of water and a potential applied to the electrochemical cell.

19. The system of claim 18, wherein the controller is operable to generate the control signal regulating the reaction time to be effective to oxidize a predetermined amount of the at least one organic contaminant prior to applying the potential to the electrochemical cell.

20. The system of claim 19, further comprising a composition sensor fluidly connected to the electrochemical cell configured to measure a concentration of the at least one organic contaminant in at least one of a first treated water and a second treated water.

21. The system of claim 20, wherein the controller is operable to generate the control signal regulating the reaction time responsive to the measurement of the concentration of the at least one organic contaminant.

22. The system of claim 18, comprising a reactor having a first inlet fluidly connectable to the source of water, a second inlet fluidly connectable to the source of the H₂O₂ containing reagent, and an outlet fluidly connectable to the inlet of the electrochemical cell.

23. The system of claim 22, further comprising a recycle line extending from a recycle outlet of the electrochemical cell to a recycle inlet of the reactor.

24. The system of claim 18, further comprising a recycle loop extending from a recycle outlet of the electrochemical cell to a recycle inlet of the electrochemical cell.

25. The system of claim 18, wherein the H₂O₂ containing reagent is selected from peroxone, and Fenton's reagent.

26. The system of claim 18, wherein the anodic oxidation material is selected from platinum, titanium oxide, a mixed metal oxide (MMO) coated dimensionally stable anode (DSA) material, graphite, graphene, boron doped diamond (BDD), lead/lead oxide, and combinations thereof.
